(19) United States
(12) Patent Application Publication
(10) Pub. No.: US 2026/0004338 A1
(43) Pub. Date: Jan. 1, 2026

(54) VIRTUAL RECOMMENDATION SYSTEM

(71) Applicant: Inter IKEA Systems B.V., DELFT (NL)

(72) Inventor: Antonia PEHRSON, Malmö (SE)

(21) Appl. No.: 18/881,544

(22) PCT Filed: Jul. 4, 2023
(86) PCT No.: PCT/EP2023/068303

§ 371 Date: Jan. 6, 2025

Related U.S. Application Data
(60) Provisional application No. 17/859,833, filed on Jul. 7, 2022.

(51) Int. Cl. G06Q 30/0601; G06T 19/00

(52) U.S. Cl. CPC G06Q 30/06443; G06Q 30/06433; G06T 19/006

(57) ABSTRACT

A computer-implemented method for guiding a user interacting with an object is provided. The method comprises receiving informational cues of a scene including the object, the informational cues pertaining to sensor-retrieved data; identifying the object based on the informational cues; extracting contextual information based on the informational cues; determining at least one interaction indicator configured to indicate an interaction performable on the identified object, the at least one interaction indicator being based at least in part on the contextual information; and guiding the user to perform the interaction on the object based on the at least one interaction indicator through control of a mixed reality (MR) device.

### BACKGROUND

Some existing e-commerce applications include features for viewing products and information about products in mixed reality (MR). Mixed reality (MR) includes a spectrum of visualization technologies ranging from virtual reality (VR) to augmented reality (AR). For example, existing e-commerce applications include features for presenting a virtual product to appear to the user in 3D using AR technologies. Such solutions allow a user to view a product digitally in a desired location. Similar solutions exist in VR. For example, a user can navigate a virtual room or store with one or more products. Additionally, some existing solutions display additional product information using AR or VR.

In some existing AR or VR solutions, information for a product is displayed with buttons or links on a 2D user-interface element. For example, information can be displayed on a 2D panel shown adjacent or on top of a product. In some examples, the information includes product name, price information for the product, user reviews for the product, and promotional information.

### SUMMARY

In general terms, this disclosure is directed to methods and systems for presenting virtual recommendations for objects. In some embodiments, the recommendations are presented in MR including either one of AR or VR. The present disclosure thus encompasses one or more sub-fields of extended reality (XR).

In a first aspect, a computer-implemented method for guiding a user interacting with an object is provided. The method comprises receiving informational cues of a scene including the object, the informational cues pertaining to sensor-retrieved data; identifying the object based on the informational cues; extracting contextual information based on the informational cues; determining at least one interaction indicator configured to indicate an interaction performable on the identified object, the at least one interaction indicator being based at least in part on the contextual information; and guiding the user to perform the interaction on the object based on the at least one interaction indicator through control of an MR device.

In a second aspect, an MR device is provided. The MR device comprises a camera, a display, at least one processor, and a memory device, the memory device storing instructions which when executed by the at least one processor cause the MR device to obtain informational cues of a scene; process the informational cues to identify an object and extract contextual information; determine at least one interaction indicator configured to indicate an interaction performable on the identified object, the interaction indicator being based at least in part on the contextual information; and guide a user to perform the interaction on the object based on the at least one interaction indicator through control of the MR device.

In a third aspect, a server comprising a processing unit is provided. The processing unit is configured to process informational cues received from an MR device to identify an object and extract contextual information; determine at least one interaction indicator configured to indicate an interaction performable on the identified object, the interaction indicator being based at least in part on the contextual information; and communicate the at least one interaction indicator to the MR device for providing guidance to a user to perform the interaction on the object based on the at least one interaction indicator through control of the MR device.

In some examples, the processing is carried out by respective processing devices, such as the at least one processor of the MR device and the processing unit of the server, of either one or both of the MR device and the server. In these examples, processing activities are not limited to one particular unit, as computing may be carried out at either one or both of the server-side and the client-side. By way of example, the MR device may carry out the processing activities, but obtain the interaction indicator for the particular object through external input from the server, or an external database being separate from the server or integrated with the server.

### BRIEF DESCRIPTION OF THE DRAWINGS

FIG. 1 illustrates an example environment for presenting virtual recommendations.

FIG. 2 illustrates an example server, in accordance with some embodiments of the present disclosure.

FIG. 3 illustrates an example method for providing a virtual recommendation.

FIG. 4 illustrates an example method for processing a stream of images to identify an object.

FIG. 5 illustrates an example method for extracting contextual information.

FIG. 6 illustrates an example method for selecting a recommendation for an object.

FIG. 7 illustrates an example user computing device, in accordance with some embodiments of the present disclosure.

FIG. 8 illustrates an example method for presenting a virtual recommendation in AR.

FIG. 9 illustrates an example method for presenting a recommendation in AR.

FIG. 10 illustrates an example method for presenting a virtual recommendation in VR.

FIG. 11A illustrates an example user interface of the object recommendation application.

FIG. 11B illustrates an example user interface of the object recommendation application.

FIG. 12 illustrates an example user interface of the object recommendation application.

FIG. 13 illustrates an example method for determining and tracking a lifecycle feature for the object.

FIG. 14 illustrates an example environment for presenting virtual recommendations.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure introduces numerous technical terms to adequately describe the invention and its various aspects, examples or embodiment. It should be noted that while specific terms are used herein for the sake of brevity, the terms in the disclosure can be interpreted in other ways by those skilled in the arts.

In examples of this disclosure, the term “stream of images” is defined. It should be noted that a stream of images is one exemplary type of informational cues being image data. Informational cues may in other examples not explicitly accounted for herein be considered as other types of data, such as mesh data, auditory data, tactile data, ambient data, motion data, olfactory data, and the like.

In examples of this disclosure, the term “recommendation” in the context of selecting a recommendation from a set of recommendations is defined. It should be noted that a recommendation may indicate an interaction performable on an identified object. To this end, the recommendation in examples herein is a type of interaction indicator, i.e., an indicator configured to indicate in what way an object can be interacted with, by a user of an MR device through the control of said MR device.

The interaction may be any type of interaction performable on the object ranging from passive to active interactions and anywhere therebetween. Passive interactions may include actions or engagements that can occur without direct or intentional input from the user, and are typically automatic or reactive in nature requiring minimal user intervention. By way of example, passive interactions may be notifications, updates, ambient displaying of information, sensor-based triggers, proximity-based triggers, contextual adaptations, content recommendations, adaptive or predictive behaviour, ambient audio, energy optimizations, and the like.

Active interactions, on the other hand, may include actions or engagements initiated by the user to interact with the surroundings including the object, and typically include user input and control. By way of example, active interactions may be physical or virtual object manipulations by way of physical or virtual touch, gesture control, voice commands, touch interactions, menu selection, drag and drop actions, camera interactions, physical control inputs, and the like.

The guiding according to the present disclosure credibly assists the user in performing a technical task by means of a guided human-machine interaction process. The technical task to be carried out depends on the object and the context of the scene as determined based on the informational cues. For example, consider a scenario where the scene is a bathroom and the object is a particular electronic device. Informational cues may be received in the form of a stream of images, and the electronic device can be identified from the stream of images. Moreover, informational cues may be received in the form of sensory inputs from a humidity sensor, and the contextual information can be extracted based on the informational cues to determine that the scene is a bathroom. This is because a bathroom is typically associated with a higher humidity compared to other comparable rooms. Based on the contextual information, the interaction indicator can be determined. In this particular example, the interaction indicator can provide indications that the electronic device should be removed from the bathroom, since the electronic device may risk of being damaged if it is maintained in the humid conditions corresponding to the bathroom. The user is subsequently guided through control of the MR device, for example by tactile input to a pair of haptic gloves, an auditory signal corresponding to a warning sound, an avatar presented in AR that visually drags the electronic device out of the bathroom, or any other similar indication, to perform the interaction to remove the electronic device from the bathroom. Accordingly, the user is guided through the human-machine interaction process to perform the technical task. Clearly, a very large number of different situations are conceivable where a user can be guided to carry out an interaction (being a technical task) on an object based on an interaction indicator which in turn in based on the contextual information.

The guiding is generally carried out through control of an MR device. Control of the MR device can be effected by the MR device itself, for instance the MR device being configured to execute one or more control commands corresponding to the interaction indicator. Alternatively or additionally, control of the MR device can be effected by an external service, for instance the MR device being controllable via one or more control commands. An external service can in this regard be a server unit, such as a cloud-based computing resource, or other external units including other devices.

In examples of this disclosure, the recommendation is explained to be provided to an MR device, such as an AR, VR or MR device. It should be noted that providing the recommendation using this approach is one exemplary type of how a user can be guided to perform the interaction on the object based on the at least one interaction indicator. Additionally or alternatively, the user may be guided to interact with the object in various different ways, such as by receiving auditory or haptic feedback, and the like.

In general terms, this disclosure is directed to methods and systems for guiding a user to interact with an object through control of an MR device. In some embodiments, the recommendations are presented in AR. In other embodiments, the recommendations are presented in VR.

Generally, the guiding of the user is effected by way of providing at least one interaction indicator, i.e., an indicator of an interaction that is performable on an identified object. As will be apparent following the examples of the present disclosure, the guiding may be provided in the form of a recommendation of how the user is to interact with the object by an interaction.

The recommendation typically includes information communicating knowledge about a product to a customer of a retailer. For example, product care information such as washing instructions can be presented to a customer using a product. Other information can also be presented with the recommendation such as materials, care instructions, disposal instruction, etc.

In some embodiments, the recommendations are selected by first identifying an object and contextual information in a scene. Contextual information can include features of a scene, features of objects in the scene, or a feature of an object related to or in combination with a feature of the scene. For example, the contextual information may determine that the object is in an outside environment (a feature of the scene), that the object includes a certain defect (a feature of the object), or that the object is too far away from a supporting wall (a feature of the object in relation to a feature of the scene). In one example, a feature of the scene includes a room type, such as a bathroom. After identifying the object and the contextual information a recommendation is selected and presented in AR, VR, or MR. In some embodiments, the scene and object are analyzed to determine a specific way to present the recommendation, for example, in AR in manner which is non-obtrusive to a user.

In some embodiments, the object is detected based on a gaze of the user wearing an MR device. The MR device, such as a pair of smart glasses, is equipped with gaze tracking technology comprising a scene camera and an eye camera. The eye cameras are configured to monitor movements and direction of the user's eyes. The scene camera is configured to capture the front of the user's view at a direction where the user is directing its gaze. The MR device may be further configured to apply computer vision algorithms, optionally employing machine learning techniques, to analyze and determine the visual input captured by the eye cameras. The MR device may be further configured to map the input obtained by the scene camera with the input obtained by the eye camera to identify the object, and accordingly determine an interaction indicator based on the object the user is looking at and the associated contextual information.

In many embodiments, machine learning is used to identify features in informational cues, such as a stream of images, including algorithms for identifying the object and the contextual information. Additionally, in some embodiments, machine learning is used to determine where to present at least one interaction indicator, such as a recommendation. In some embodiments, a machine vision algorithm identifies an object in a stream of images. In some embodiments, the machine vision algorithm further identifies features of the object. In some embodiments, the features are further used to determine where to present the recommendation. In some embodiments, contextual information is identified using a machine learning algorithm which predicts contextual information based on features identified in informational cues, such as a stream of images. For example, an intended use of an object can be predicted based on the detected environment of the object, such as predicting a user will wash an object based on detecting that the object is placed near a sink and the recommendation will include washing instructions to the user in AR.

In some embodiments, the recommendation is presented to provide the most useful, relevant, or important information to a user based on the contextual information. For example, safety information may be presented when the contextual information identifies a potential safety issue but if no safety issue is detected then object care recommendations are provided. In some examples, the recommendation provided to a user is predefined based on a set of rules. In other embodiments, a machine learning algorithm can be used to score the recommendation based on the identified contextual information as well as other input data.

Reference to the figures will now be made following this paragraph. The specific exemplary embodiments described with reference to the figures relate to informational cues in the form of a stream of images. Moreover, a set of recommendations are defined, where a particular recommendation is selected from this set of recommendations. The selected recommendation is then sent to an AR device such that the recommendation can be presented in AR. As discussed above, the skilled person will appreciate other types of informational cues not explicitly accounted for herein. Moreover, the skilled person will appreciate that the at least one interaction indicator configured to be performable on the identified object is one type of recommendation. As such, the set of recommendation need not necessarily be determined, and a recommendation need not necessarily be selected therefrom. Instead, other conceivable examples include determining at least one interaction indicator, and guiding the user to interact with the object by the interaction based on the determined at least one interaction indicator.

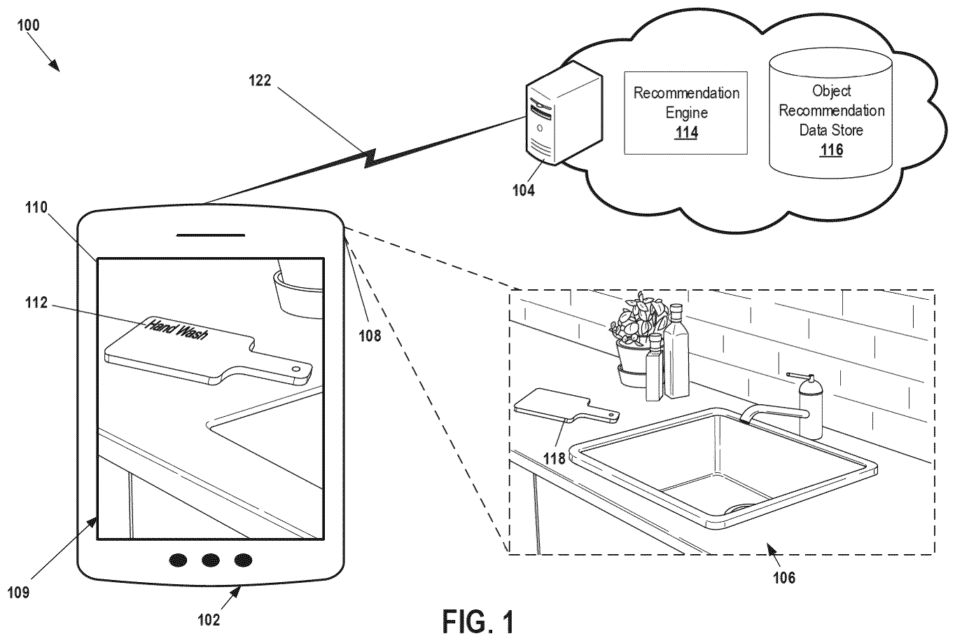

FIG. 1 illustrates an example environment 100 for presenting virtual recommendations. The environment 100 includes a user computing device 102 connected to a server 104 via a network 122. In some embodiments, the user computing device includes a camera 108 which captures a scene 106. In some embodiments, the scene 106 may be captured by a plurality of user computing devices comprising respective cameras, and the scene 106 may be composed by combining the inputs of the respective cameras of the plurality of user computing devices. In other embodiments, the scene 106 is a virtual scene which is presented on the user computing device 102. The user computing device 102 includes an object recommendation application 110, which presents a recommendation 112 in AR, MR or VR. The server 104 includes a recommendation engine 114 and an object recommendation data store 116. The scene 106 includes an object 118.

The user computing device 102 operates to present a virtual recommendation for an object. In some embodiments, the user computing device 102 is an AR device, such as a smart phone, tablet, smart glasses, etc. In some embodiments, the user computing device 102 is a VR device, such as a VR headset, smart phone, tablet, etc. In some embodiments, the user device includes a camera 108 and a display 109.

In AR embodiments, the camera 108 captures a stream of images of the scene 106. The stream of images are received by the object recommendation application 110 which communicates with the server 104 to operate the recommendation engine 114. The recommendation engine 114 processes the stream of images to determine a recommendation for the object. In VR embodiments, the camera 108 is not required. The display 109 presents the virtual recommendation in either AR, VR, or MR.

As discussed above, the stream of images may be one type of information received as informational cues. Generally, the term informational cues refers to visual or perceptual elements present in the scene the can provide information (or cues) to a device. The informational cues may be derived from sensory inputs received by a device, such as the MR device. The informational cues may include one of image data (i.e., the stream of images), mesh data, auditory data, tactile data, ambient data, motion data, olfactory data, or any combination thereof. Mesh data in this context may include vertices, edges, faces or normals, etc., used to represent objects or surfaces of the scene. Any informational cues that can assist in the identification of the object may be included.

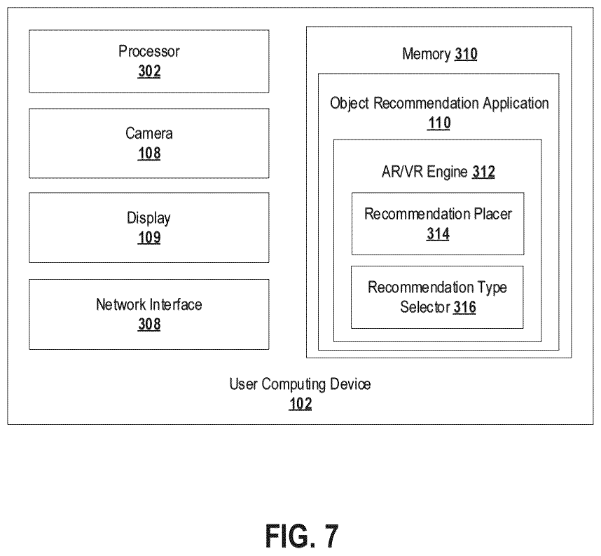

The user computing device 102 operates an object recommendation application 110. The object recommendation application displays the recommendation 112. In some embodiments, the recommendation is presented as part of a 3D object. In some embodiments, the 3D recommendation is presented in a realistic way. For example, the 3D recommendation may be presented on a 3D virtual tag attached to the object. In some embodiments, the recommendation overlays a portion of the object. In some embodiments, the recommendation includes information which would be presented on the packaging of a product. An example of the user device is illustrated and described in reference to FIG. 7.

In some embodiments, the recommendation 112 for the object can include a recommendation related to the object's materials, the object dimensions, object care instructions, object disposal information, object sustainability information, assembly information, installation error information, consumable/replacement information, object intended use information, or any combination thereof.

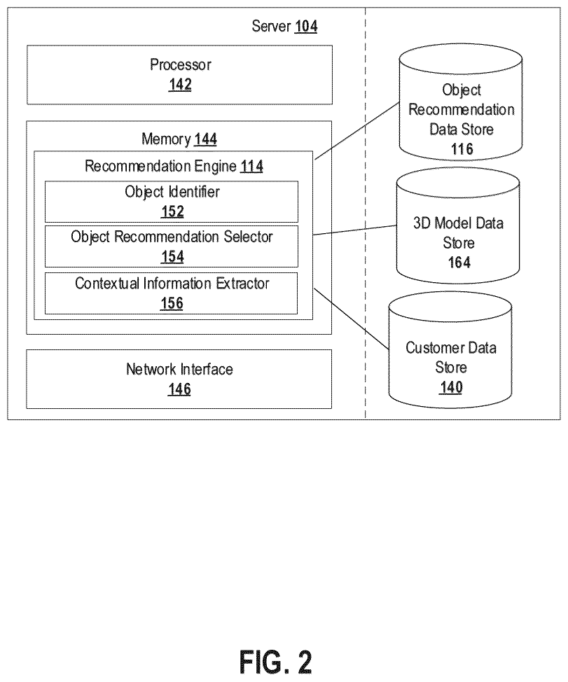

The server 104 operates to process the stream of images capturing the scene 106 to identify a relevant recommendation for the object 118. In some embodiments, the server 104 is part of a retailer system and/or an e-commerce system. Although only one server is shown, some embodiments include multiple servers. In these embodiments each of the servers may be identical or similar and may provide similar functionality (e.g., to provide greater capacity and redundancy, or to provide services from multiple geographic locations). Alternatively, in these embodiments, some of the multiple severs may perform specialized functions to provide specialized services. Various combinations thereof are possible as well. An example of the server 104 is illustrated and described in reference to FIG. 2.

The server 104 includes a recommendation engine 114. The recommendation engine 114 selects a recommendation 112 for the object 118. In some embodiments, the recommendation engine 114 processes a stream of images to identify an object and extract contextual information. The object and contextual information is used to select a recommendation relevant for a user. Example methods for identifying an object, extracting contextual information, and selecting a recommendation are described herein.

The server 104 includes or interfaces with an object recommendation data store 116. The object recommendation data store 116 includes one or more recommendations for a plurality of objects. In some embodiments, the object recommendation data store 116 is the same datastore which presents object information on a retail website and/or stores digital manuals for a plurality of objects provided by the retailer.

The environment 100 can include a scene 106 which can be either a virtual reality scene or an augmented reality scene. The augmented reality scene can include any physical space. For example, an augmented reality scene could include a room in a house, an office, a store, warehouse, backyard, event space, an event/convention venue, staged model home/apartment, etc. In other examples, the scene 106 is a virtual reality scene, such as a virtual reality store or a virtual reality home. In some embodiments. the scene is presented with a furnishing planner.

The scene 106 includes the object 118. In the example shown, the object is a cutting board with a virtual recommendation 112 to handwash the cutting board. In some embodiments, the object 118 can be any object. In other embodiments, the object 118 is a product which was sold by a specific retailer. Examples of the object 118 include home furnishings, electronic devices, musical instruments, food, plants, medications, house hold items (such as cutlery, napkins, candles, pots), etc. The object 118 may be a part of a larger object. For example, the object 118 may be a shelf on a cabinet or a cushion on a couch.

The network 122 connects the server 104 to a plurality of computing devices including the user computing device 102. In some examples, the network 122 is a public network, such as the Internet. In example embodiments, the network 122 may connect with computing devices through a Wi-Fi network or a cellular network.

FIG. 2 illustrates an example server 104. In some embodiments, the server includes a processor 142, a memory 144, and a network interface 146. In some embodiments, the server 104 interfaces with an e-commerce system or platform. In other embodiments, the server is integrated with an e-commerce system. The memory stores instructions to execute a recommendation engine 114. The recommendation engine 114 includes an object identifier 152, a recommendation selector 154, and a context identifier 156. In some embodiments, the recommendation engine 114 interfaces with an object recommendation data store 116, a customer data store 140, and a 3D model data store 164.

The processor 142 comprises one or more central processing units (CPU). In other embodiments, the processor 142 includes one or more digital signal processors, field-programmable gate arrays, or other electronic circuits. In some embodiments, the processors include one or more processors (e.g., virtual or physical processors) executing instructions to perform algorithms to achieve desired results. Additionally, in some embodiments, additional input/output devices are operatively connected with the processor 142.

The memory 144 is operatively connected to the processor 142. The memory 144 typically includes at least some form of computer-readable media. Computer readable media can include computer-readable storage media and computer-readable communication media.

Computer-readable storage media includes volatile and nonvolatile, removable and non-removable media implemented in any device configured to store other data. Computer-readable storage media includes, but is not limited to, random access memory, read-only memory, flash memory, and other memory technology, compact disc read-only memory, BLUERAY® discs, digital versatile discs or other optical storage, magnetic cassettes, magnetic tape, magnetic disk storage or other magnetic storage devices, or any other medium that can be used to store the desired information and that can be accessed by the server 104. In some embodiments, computer-readable storage media is non-transitory computer-readable storage media.

Computer-readable communication media typically embodies computer-readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or directed wired connection, and wireless media such as acoustic, radio frequency, infrared, and other wireless media. Combinations of any of the above are also included within the scope of computer-readable media.

A number of program modules can be stored in the memory 144 or in a secondary storage device, including an operating system, one or more application programs, and other program modules, and program data. The memory 144 stores instructions for a recommendation engine.

The recommendation engine 114 includes an object identifier 152, an object recommendation selector 154, and a context identifier 156. In some embodiments, the recommendation engine 114 interfaces with an object recommendation data store 116, a customer data store 140, and a 3D model data store 164.

The network interface 146 operates to enable the server 104 to communicate with one or more computing devices over one or more network, such as the network 122 illustrated in FIG. 1. For example, the server 104 is configured to communicate with the user computing device 102 to perform some of the methods disclosed herein. The network interface can include wired and/or wireless interfaces.

In some embodiment, the recommendation engine 114 interfaces with one or more data stores. In some embodiments, the data stores are associated with an e-commerce system or platform which stores product information for one or more retailers. In the example shown, the data store interface operates to send and receive data from an object recommendation datastore and a customer data store.

In some embodiments, the object recommendation data store 116 is a centralized retail data store which includes information about products sold by the retailer including product details, product materials, product care instructions, care instructions, safety information, compliance information, sustainability information, recycling information, assembly information, measurements, object weight, user reviews, images of the product, pricing information, user manuals etc. In some embodiments, the object recommendation data store 116 stores recommendations and object information in a plurality of different languages.

In typical embodiments, the recommendation engine 114 is not required to interface with a customer data store 140. However, in some embodiments, the recommendation engine 114 interfaces with the customer data store 140 to retrieve customer information. For example, the customer data store 140 may track products sold to a customer and use these products to assist with the identification of objects or for identifying contextual information.

In some embodiments, the 3D model data store stores 3D models for a plurality of objects. In some embodiments, the 3D models are annotated based on features to allow the object identifier 152 to quickly filter models based on a set of features identified in the incoming stream of images.

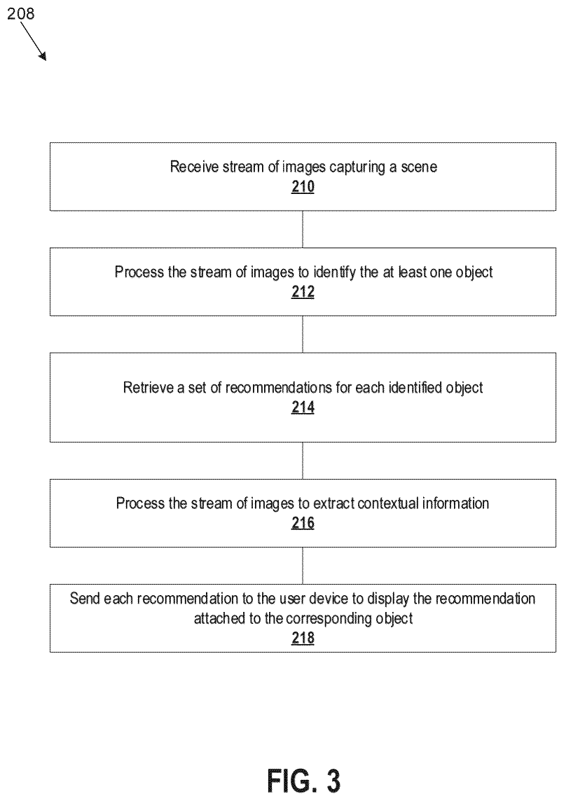

FIG. 3 illustrates an example method 208 for providing a virtual recommendation. In some embodiments the method 208 operates as part of the recommendation engine 114 at a server 104. The method 208 includes the operation 210, 212, 214, 216, and 218.

In an AR embodiment, the operation 210 receives a stream of images capturing a scene with at least one object. In some embodiments, the stream of images are continually processed to update as a user navigates the scene. In VR embodiments, data defining a scene is received instead of a stream of images.

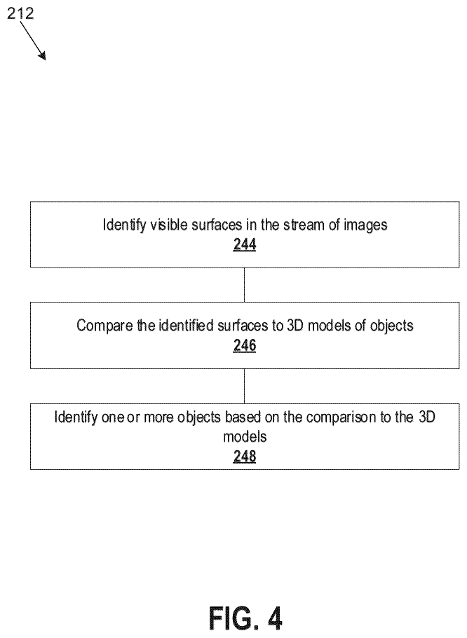

The operation 212 processes the stream of images to identify the at least one object. In some embodiments, the object is identified using a machine vision algorithm. In some embodiments, the stream of images are processed to identify 3D shapes and matching the 3D shapes with a 3D model of the object using a visual search algorithm. An example method for identifying an object in a stream of images is illustrated and described in reference to FIG. 4.

The operation 214 retrieves a set of recommendations for each of the at least one object. In some embodiments, the set of recommendations are retrieved from a data store which stores object information. In some embodiments, the set of recommendations are predefined. In other embodiments, a machine learning model extracts recommendations from the data for the object. In alternative embodiments, the set of recommendations are parsed for a website of a retailer. The set of recommendations can include different languages and/or 3D symbols or pictures which represent the recommendation. For example, a recommendation for how to use an object may include an image of the object with the defect caused by the improper use.

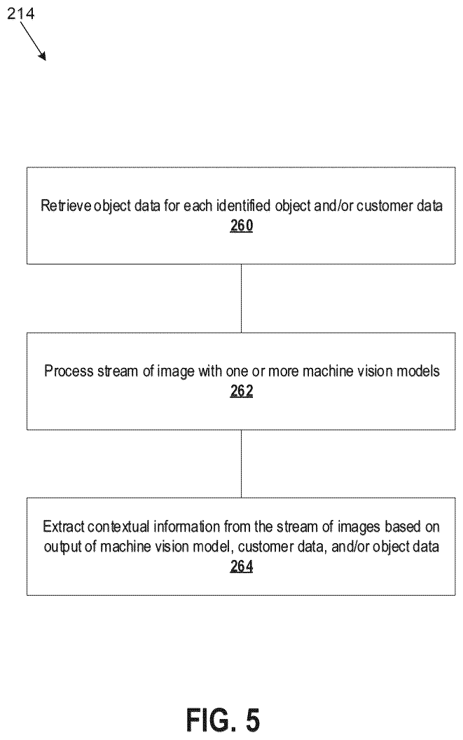

The operation 216 processes the stream of images to extract contextual information. In some embodiments, the contextual information is related to the scene, the object, or a combination of the scene and the object. In some embodiments, the contextual information is further based on additional data. For example, location data (e.g., as determined using GPS data at a GPS receiver) is used to determine a location. The location may determine that the user is at a showroom for a retailer and the contextual information includes known features of the showroom. Contextual information may further be based on the condition of the object. For example, the contextual information may include the current lifecycle period of the object. In some embodiments, lifecycle periods are defined as different stages an object goes through from the creation of the object to the destruction of the object. In some embodiments, each period is defined by the types of recommendations which are relevant for the object at the different stages in the object's lifecycle. For example, lifecycle period an object at or near the end of life would include instructions for disposal or recycling of the object. Contextual data may further include user data, such as date an item was purchased, preferred language, annotated floorplan for a user, stored VR layouts with various objects/products, etc. An example method for extracting contextual information is illustrated and described in reference to FIG. 5.

Further examples of contextual information which can be extracted include a setting, a geographic location, a lifecycle period of the object, an environment type; an object defect, an object use or misuse, an object safety issue; or any combination thereof.

The operation 218 selects a recommendation based at least in part on the extracted contextual information. For example, if the contextual information indicates that a user is about to wash the object, the operation 218 would select a recommendation with washing instructions. Similarly if the contextual information indicates the user is installing the object the operation 218 can select an installation instruction. In some embodiments, a set of rules define which recommendation is selected. For example, the rules may define a default recommendation, and one or more recommendations which are displayed in certain circumstances. In some embodiments, the rules prioritize safety recommendations when a potential safety issue is detected. For example, the recommendation including a safety warning is selected when a bookshelf, that is required to be anchored on a wall is identified as not being located next to a wall.

In some embodiments, a machine learning model is used to select a recommendation. In one embodiment, the machine learning model may be trained on customer reviews and object return data to determine defects or issues with an object and select recommendations which may prevent common defects. In some embodiments, images of objects with deformed shapes are saved including images of returned products or customer submitted images of defective products.

The machine learning model may be implemented to identify anomalies of the object. An anomaly is an indication that the object differs from an expected appearance and/or functionality thereof. To identify anomalies, the machine learning model may be trained on object data of a plurality of objects. The machine learning model may be configured to receive an anomaly identification request of an object of interest, for example in response to the object being detected. The machine learning model being trained on object data may be configured to process the anomaly identification request to determine whether the object of interest is associated with an anomaly. In response to having processed the anomaly identification request, the user may be provided with feedback of an outcome of the anomaly identification request indicating whether or not the object of interest is associated with an anomaly. To this end, the machine learning model is configured to predict anomalies based on previously performed identifications. The machine learning model may further analyze the outcome of the anomaly identification request to improve further anomaly classifications. Purely by way of example, the machine learning model may employ supervised or unsupervised learning algorithms known in the art, including but not limited to neural networks, binary, multi-class or multi-label classifications, clustering algorithms, regression algorithms, support vector machines, kernel estimation, decision trees, and so forth.

The operation 220 sends each recommendation to the user device to display the recommendation attached to the corresponding object. In some embodiments, the recommendation may be sent with instructions on where to place the recommendation and a type or style of the 3D element used for presenting the recommendation.

In many embodiments, the method 208 repeats as a user navigates a scene providing a near continuously updated stream of images.

FIG. 4 illustrates an example method 212 for processing a stream of images to identify an object. The method 212 is an example of the operation 212 illustrated and described in reference to FIG. 3. The method 212 includes the operations 244, 246, and 248.

The operation 244 identifies visible surfaces of an object in the stream of images. In typical embodiments, a machine vision algorithm is used to identify visible surfaces in the stream of images.

The operation 246 compares the identified surfaces to 3D models of objects. The identified surfaces are compared to 3D models using the machine vision algorithm. In some embodiments, the 3D models are associated with products sold by a particular retailer. In some embodiments, the 3D models are annotated and indexed to allow for the machine vision algorithm to quickly compare the visible surfaces to relevant 3D models. For example, the 3D models can be indexed based on the type of room and annotated based on typical positioning of the object. In this example, the machine vision algorithm can identify the type of room and filter models based on the identified type of room and then compare surfaces which are indicated as likely to be visible.

The operation 248 identifies one or more objects based on the comparison to the 3D models. In some embodiments, the operation 248 predicts the likelihood that a visible surface is a particular object and if the likelihood is above a set threshold the operation 248 will identify the object.

In some embodiments, a specific surface of an object is identified. For example, the recommendation may be provided for a specific surface or material of the object. In some embodiments, identifying the specific surface is done by first identifying the object and retrieving a 3D model of the object. The 3D model of the object includes annotated surfaces and is used to map the annotated surfaces with the identified object. For example, legs of the table may be annotated with material information e.g., a metal type which is different from the surface of the table. Identifying a specific surface or type allows the methods and systems to provide a surface or part specific recommendation. Advantages for identifying the object prior to identifying the specific surface includes improving the accuracy and efficiency for identifying a specific surface.

FIG. 5 illustrates an example method 214 for extracting contextual information. The method 214 is an example method for the operation 214 illustrated and described in reference to FIG. 3. The method 214 includes the operations 260, 262, and 264.

The operation 260 retrieves object data for each identified object. In typical embodiments, the object data is retrieved from a centralized data store which includes object information to a large collection of objects. In some embodiments, the collection of objects includes objects sold by a particular retailer. In some embodiments, the object data further includes annotated images of the object with a defect. The annotations may describe what issues caused the defect and a recommendation for avoiding the defect. In typical embodiments, the object information will include a set of recommendations for each of the objects.

The operation 262 processes a stream of images with one or more machine vision models. The machine vision models may include additional inputs to improve the accuracy of the predicted contextual information. For example, objects purchased by the user, location data, environment data (e.g., humidity, temperature, as determined by sensors connected to the user device) can be used as inputs to extract contextual information.

The operation 264 extracts contextual information based on the output of the one or more machine vision model, customer data, and/or product data. In some examples, the contextual information is further based on tracking where a user is in an environment. For example, a user may map their house and annotate different rooms and based on the stream of images and the annotated map the operation 264 determines what room the user is in. Additionally, contextual information can further include information extracted from user reviews and identified in the stream of images. For example, if a user review indicates a product was deformed from being placed outside this information can be extracted and compared to an environment identified in the stream of images in order to provide a care recommendation to avoid the defect. The contextual information can further be based on system settings, such as language or accessibility settings.

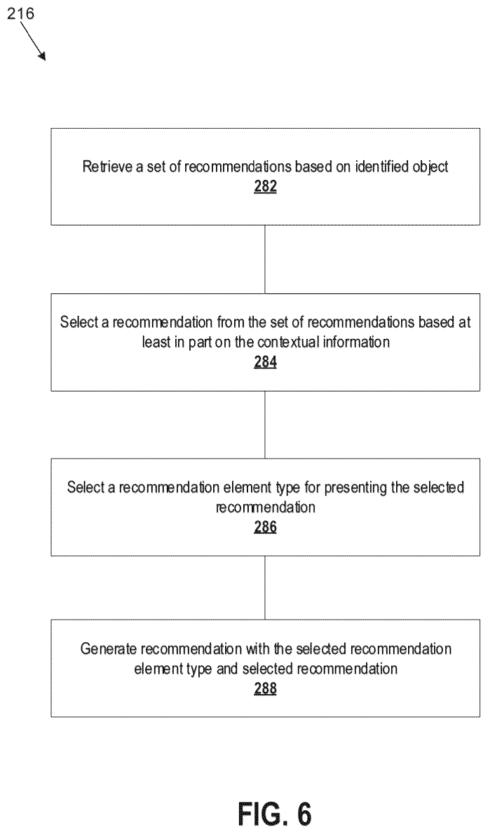

FIG. 6 illustrates an example method 216 for selecting a recommendation for an object. In some embodiments, the method 216 is performed as part of the operation 216 illustrated and described in reference to FIG. 3. In typical embodiments, the operation 282 is performed at the server with the recommendation engine. However, in some embodiments, some or all of the operations are executed locally at a user computing device. The method 216 includes the operations 282, 284, 286, and 288.

The operation 282 retrieves a set of recommendations based on the identified object. In some embodiments, a database stores recommendations for each of the available objects. In other embodiments, recommendations can be scraped of a retailer website for a product corresponding to the identified object.

The operation 284 selects a recommendation from the set of recommendations based at least in part on the contextual information. The contextual information is used to determine which recommendations are likely to be relevant to a user at a specific time. In some embodiments, the recommendation is selected using a trained machine learning model. The machine learning model can be trained on user interactions with the app and customer reviews of the object. In other embodiments, a set of rules or a policy is defined which is used to select a recommendation. In some embodiments each recommendation is scored based at least in part on the contextual information and the highest scoring recommendation is selected. The machine learning model may utilize any suitable algorithm commonly applied in the art, for instance the algorithms discussed above.

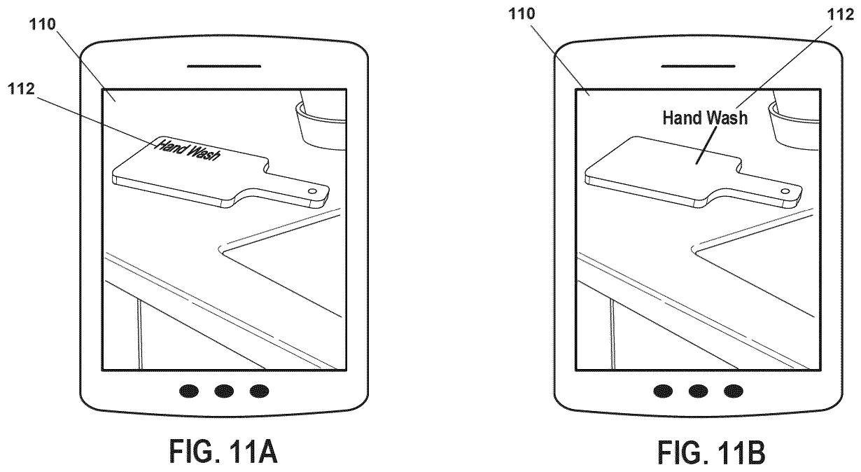

The operation 286 selects a recommendation element type for presenting the selected recommendation. In some embodiments, the element type is a 3D element which corresponds to how a user would expect the information to be presented physically on the object. In other embodiments, the element is selected to minimize obstruction of the object or scene. For example, the recommendation can be printed on a plain surface of the object (e.g., as illustrated in FIG. 11A). In other embodiments, the recommendation is presented adjacent to the object to avoid obstructing the object (e.g., as illustrated in FIG. 11B).

The operation 288 generates a recommendation with the selected recommendation element and selected recommendation. In some embodiments, an AR engine on the user computing device generates a graphic which overlays a stream of live images to present the recommendation in AR. In some embodiments, a VR engine places the virtual recommendation in the VR scene.

In some embodiments, identifying a recommendation comprises analyzing an environment surrounding the object. For example, identifying an object and the objects approval for indoor use but not for use in a bathroom (or other room with high humidity) and figuring out from contextual information (e.g., from other objects identified in the scene from the stream of images) that the object is in a bathroom environment and then recommending the user move the product to another environment (or recommend other products, approved for bathroom use). Another example includes, identifying an object which, for safety, requires it to be attached to the wall but recognizing that it is not placed close enough to any wall and recommending the user to anchor the object to the wall. A further example includes, identifying an object not approved for children in a context with other objects which are approved children's products and notifying the customer that the product is not approved for children.

In some embodiments, the recommendation is translated to specific language based on a user account setting, system setting of the user computing device, and/or GPS data. In some embodiments, the recommendation is presented as 3D symbols.

FIG. 7 illustrates an example user computing device 102. The user computing device 102 includes a processor 302, a camera 108, a display 306, a network interface 308, and a memory 310. The memory stores instructions for an object recommendation application 110 and an AR/VR engine 312. The AR/VR engine 312 includes a recommendation placer 314 and a recommendation type selector 316.

The user computing device 102 includes a processor 302, network interface 308, and memory 310. Examples of processors, memories, and network interfaces are described herein. For example, the processor 142, memory 144, and network interface 146 illustrated and described in reference to FIG. 2.

In some embodiments, the user computing device 102 includes a camera 304. The camera 108 is used to capture images of a scene. The camera 108 can be any type of camera typically used on mobile computing devices, including augmented reality devices. In VR examples, the camera 108 is not required.

Other sensors can also be used to capture 3D details of a physical environment. For example, a LIDAR sensor, ultrasonic distance sensor, or using sound generated by a speaker and analyzing the echo received at a microphone. In other embodiments, images from two or more cameras are used to calculate 3D features in the physical environment.

The display 109 can be any electronic display which is able to present the virtual recommendations. In some examples, the display is a screen, such as touch screen on a mobile device, a television, monitory, projector, holographic etc. In some examples, the display is specialized for use with augmented reality and/or virtual reality.

A number of program modules can be stored in the memory 310 or in a secondary storage device, including an operating system, one or more application programs, and other program modules, and program data. In the example shown, the memory 310 stores instructions for an object recommendation application 110.

The object recommendation application 110 operates to present recommendations to a user. In some embodiments, the object recommendation application 110 is an AR application. In other embodiments, the object recommendation application 110 is a VR application.

The AR/VR engine 312 operates the logic for presenting the recommendation in AR or VR. The AR/VR engine 312 includes a recommendation placer 314 and recommendation type selector 316.

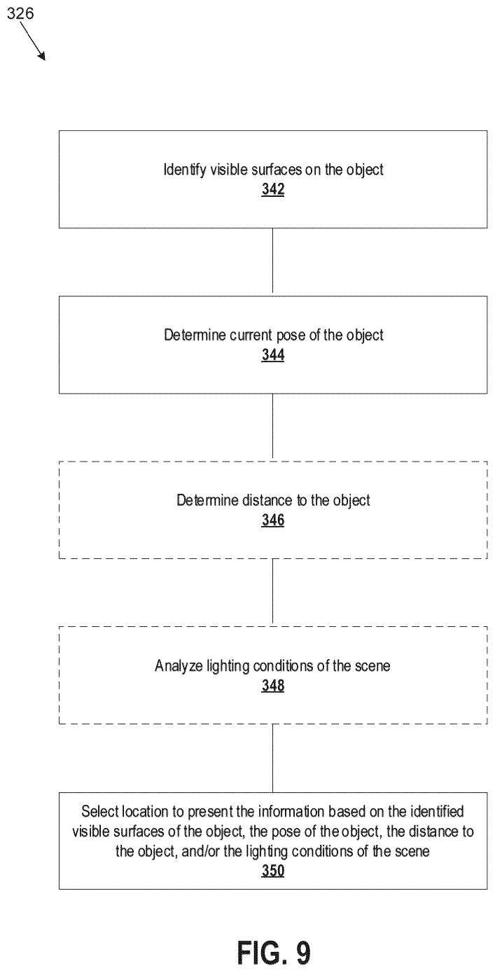

The recommendation placer 314 determines a location to place the virtual recommendation. In some embodiments, the recommendation is placed at a location which is easily viewed by the user while minimizing obstruction of the object and the surrounding scene. An example method performed by the recommendation placer 314 is illustrated and described in reference to FIG. 9. In typical embodiments, the recommendation placer 314 determines where and how to display the recommendation. In some embodiments, the location is manually defined based on the surface which is most likely to be used or displayed. For example, a 3D model of the object may include annotations defining the most used or displayed surface.

In some embodiments, the recommendation placer 314 determines a specific surface of an object for placing a recommendation associated with a specific surface of the object. For example, a particular surface of an object may include recommendation with a specific care instruction (e.g., based on a material, design, etc.).

In some embodiments, multiple recommendations are presented on an object attached to different surfaces. For example, multiple surfaces of different materials are identified and a recommendation is selected for each of the different surfaces. The recommendations are placed attached to the corresponding surface.

The recommendation type selector 316 selects an element to present the recommendation. The element can be a 2D or 3D element. In some embodiments, the 3D element is a copy of a realistic element for attaching information to an object. For example, a couch cushion may include a tag and the 3D element would match the tag with the information. In other embodiments, the element is selected to present the recommendation clearly while minimizing the obstruction of the user's view.

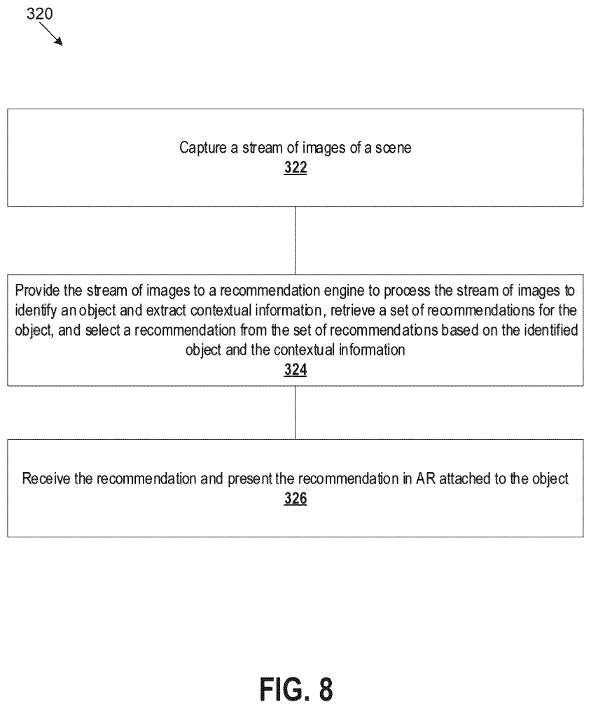

FIG. 8 illustrates an example method 320 for presenting a virtual recommendation in AR. In some embodiments, the method 320 is performed on the user computing device 102, for example, as illustrated and described in reference to FIGS. 1 and 7. The method 320 includes the operations 322, 324, and 326.

The operation 322 captures a stream of images of a scene. In typical embodiments, the user device includes a camera which captures a stream of images which are processed and updated as a user navigates a scene.

The operation 324 provides the stream of images to a recommendation engine to process the stream of images to identify an object and extracts contextual information from the stream of images, retrieves a set of recommendations for the object, and selects a recommendation from the set of recommendations based on the identified object and the contextual information. An example method performed at the recommendation engine for the operation 324 illustrated and described in reference to FIG. 3.

The operation 326 receives the recommendation and presents the recommendation in AR attached to the object. An example method for presenting the recommendation in AR is illustrated and described in reference to FIG. 9.

FIG. 9 illustrates an example method 326 for presenting a recommendation in AR. In some embodiments, the method 326 is part of the operation 326 illustrated and described in reference to FIG. 8. In some embodiments, the method 326 includes the operation 342, 344, 346, 348, and 350.

The operation 342 identifies visible surfaces on the object. In some embodiments, the stream of images are processed to determine if there are any object occluding any portion of the object.

The operation 344 determines a pose of the object. In some embodiments, the visible surfaces of the object are analyzed to determine the current position and orientation of the object.

In some embodiments, the method 326 includes the operation 346 which determines a distance to the object. In some embodiments, a machine vision algorithm calculates the distance based on the received stream of images. In typical embodiments, the operation 346 is not required. In some embodiments, the type of element used to present the recommendation is updated based on the distance the user is from the object.

In some embodiments, the method 326 includes the operation 348 which analyzes the lighting conditions of the scene. In typical embodiments, the operation 346 is not required. The lighting conditions are analyzed in order to place the recommendation in a location with neutral lighting.

The operation 350 selects a location to present the information based on the identified visible surfaces of the object, the pose of the object, the distance to the object, and/or the lighting conditions of the scene. In some embodiments, each object included in the object data store includes a set of predefined points for presenting the virtual recommendation. In some embodiments, each predefined point is scored based on the visible surfaces, pose of the object, distance from the object, and/or lighting of the scene. For example, a point which is visible on a front surface to the view of the user is selected to virtually attach a 3D element with the recommendation. In some embodiments, a set of rules define where the recommendation is placed. For example, the rules may define selecting a visible point which is on or closest to the front surface. In some embodiments, the distance from the object is used to determine a size for the 3D element presenting the recommendation. This allows the recommendation to adjust to provide useful information to the user while not obstructing the user's view of the scene.

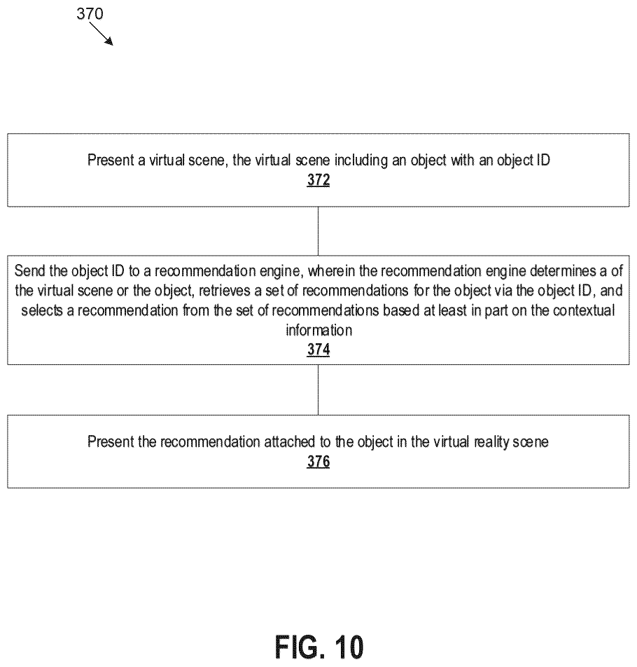

FIG. 10 illustrates an example method 370 for presenting a virtual recommendation in VR. In some embodiments, the method 370 is performed on the user computing device 102, for example, as illustrated and described in reference to FIGS. 1 and 7. The method 370 includes the operations 372, 374, and 376.

The operation 372 presents a virtual scene, the virtual scene including an object with an object ID. In many embodiments, multiple objects each with an object ID are presented. In some embodiments, the virtual scene is a customized home furnishing layout. In some embodiments, the virtual scene is a virtual showroom.

The operation 374 send the object ID to a recommendation engine, wherein the recommendation engine determines contextual information, retrieves a set of recommendations for the object via the object ID, and selects a recommendation from the set of recommendations based at least in part on the contextual information. In some embodiments, the VR scene is mapped with different contextual information depending on the current view of the user, object ID, or stored variables. In some embodiments the contextual information includes an indication that the user is viewing the scene in VR. For example, cleaning instructions may not be relevant to a user viewing a virtual object. An example method performed at the recommendation engine is illustrated and described in reference to FIG. 3.

The operation 376 presents the recommendation attached to the object in the virtual reality scene. In some embodiments, the recommendation is attached to an object as it would be in a real world scene. For example, a virtual tag may be attached to an object or virtual packaging. In some embodiments, the recommendation is presented in 3D adjacent to the object to avoid occluding the object.

In some VR embodiments, the VR scene is connected to a user's account. For example, a user may have one or more VR scenes (e.g., a virtual home, a virtual office, etc.) connected with an account. When the user makes a purchase from a retailer connected with the account, information about the object purchased by the user is sent to the account and added to one or more of the VR scenes. In some embodiments, the user can add the purchased object to the customized scene. In some embodiments, the user can interact with or use the object when they are navigating the virtual scene. For example, if a user has an account with a virtual kitchen and they have purchased a cutting board, a virtual object in the form of a virtual cutting board can be placed in the kitchen. The user can pick up the virtual cutting board as they navigate the virtual scene and virtual recommendations are displayed. In some embodiments, the recommendations are based on contextual information such as when the object was purchased. For example, if the cutting board was purchased one year ago the recommendation may provide care instructions relevant at one year (e.g., a recommendation to apply oil to the cutting board). In another example, if the user places the virtual product in a virtual scene which is not suitable for the product, a recommendation to move the object is selected and presented to the user in VR. Many other examples of contextual information can be extracted from the VR scene.

FIG. 11A illustrates an example user interface of the object recommendation application 110. In the example shown, the recommendation 112 overlays the object in a nonobtrusive manner.

FIG. 11B illustrates an example user interface of the object recommendation application 110. In the example shown, the recommendation 112 is presented adjacent to the object with a line connecting the recommendation to the 112 to the object. In this manner the recommendation is nonobtrusive to the object.

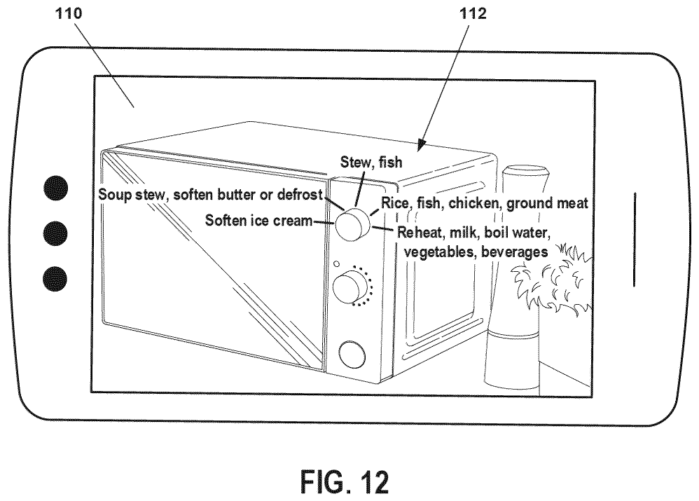

FIG. 12 illustrates an example user interface of the object recommendation application 110. In this example, the recommendations provide instructions on how to use the object. For example, the recommendations include settings for preparing different types of food. In a related embodiment, contextual information may be used to determine a type of food and the recommendation will provide specific instructions for the identified type of food.

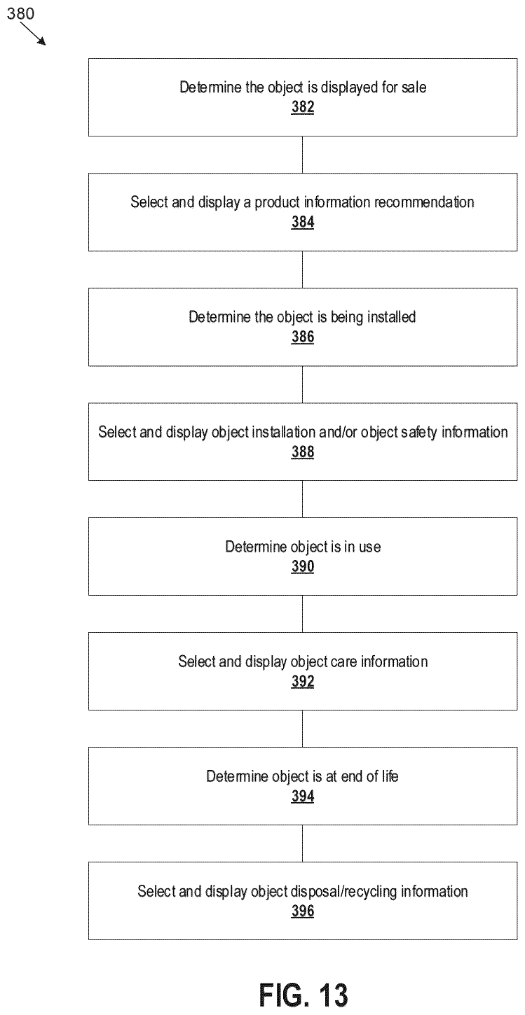

FIG. 13 illustrates an example method 380 for determining and tracking a lifecycle feature for the object. The method 380 includes the operations 382, 384, 386, 388, 390, 392, 394, and 396. The method 380 shows the different recommendations presented based on particular lifecycle period.

The operation 382 determines the object is displayed for sale and, in response, the operation 384 selects and displays a recommendation for the object. For example, information which is of interest to a potential buyer of the object is displayed as part of the recommendation. For example, a purchaser may be interested in knowing a material used in the object or sustainability information to help with the decision of which object to purchase. In some embodiments, the object is displayed for sale in a virtual environment.

The operation 386 determines the object is being installed and, in response, the operation 388 selects and displays object installation and/or object safety information. In some embodiments, the recommendation is updated as a user completes installation steps. In some embodiments, the recommendation includes warnings when a user makes an installation error.

The operation 390 determines that the object is in use and, in response, the operation 392 selects and displays object care information. For example, a recommendation to wash both sides of a cutting board is provided to a user when the cutting board is in use. Many other examples are disclosed herein.

The operation 394 determines the object is at the end of life and, in response, the operation 396 selects and displays object disposal/recycling information. In some embodiments, the operation 396 queries for local recycling and disposal rules and presents a disposal recommendation based on the local rules.

In some embodiments, a guide provides a series of recommendations to a user at different points in the lifecycle. For example, a user may be given a set of recommendations as tasks to view at different lifecycle stages. In some embodiments, recommendations are automatically displayed on the user device upon unboxing the object. Examples of lifecycle periods include: when the object is on display for sale, when the object is being installed; when the object is in use, and when the object is at the end of life.

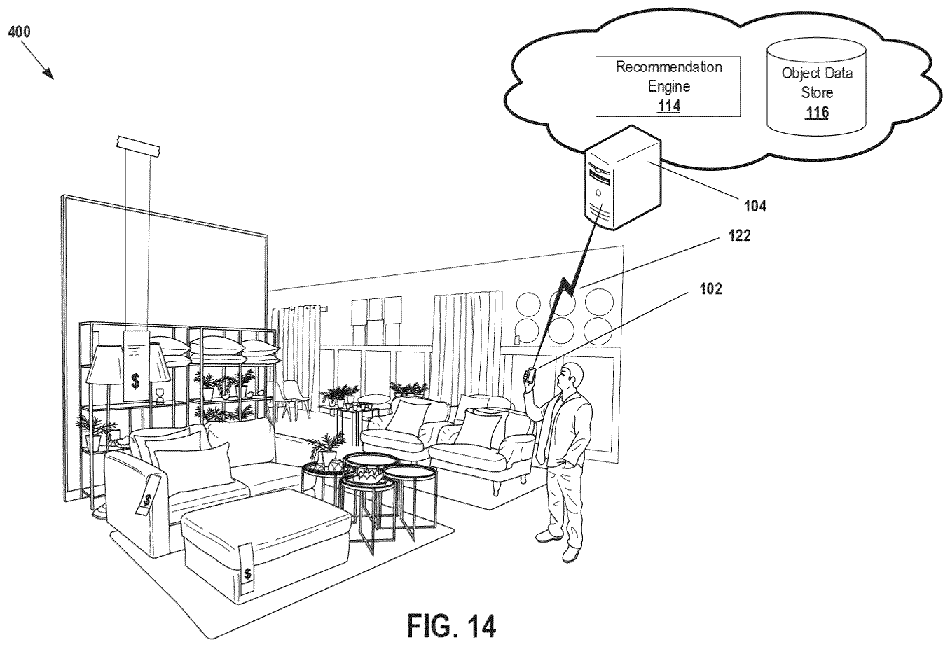

FIG. 14 illustrates an example environment 400 for presenting virtual recommendations. The environment 400 includes a user computing device 102 and a server 104 connected via a network 122. The server includes a recommendation engine 114 and an object recommendation data store 116. The environment 400 is similar to the environment 100 illustrated in FIG. 1. In the example of FIG. 14 the environment is a showroom. The recommendation selected may further be based on the environment being a showroom. For example, a recommendation for a particular material is presented to a user viewing a specific object. In some embodiments, the environment 400 is a virtual show room. In addition to the examples shown in FIG. 1 and FIG. 14, the systems and methods disclosed herein can be used in a variety of different locations including homes, offices, stores, or another public or private space where an object of interest is located.

In some embodiments, a computer implemented method for guiding a user in interacting with a product is disclosed. The method includes: (1) identifying an object, matching object to a model stored in a database, and providing information of the object. Wherein the information of the object can include one or more of care instructions, intended use of the object, or an intended age range for using the object, etc. In some embodiments, the computer implemented method includes identifying the instruction on how to handle or take care of the product by comparing a current shape or condition of the product with an original shape or condition of the product (e.g. from a database). In some embodiments, the instructions recommend a suitable action based on the comparing a current shape or condition of the product with an original shape or condition of the product.

Further example implementations of some embodiments of the present disclosure include: (1) identifying a surface of an object associated with a specific care instruction (e.g. a cutting board requires to be oiled every 6 months); (2) identifying that the specific surface differs substantially from the original (e.g. a bent cutting board- comparing the scan of the object with the original 3D file) and recommending suitable actions (e.g. always wash both sides of the board); (3) identifying the different parts of the object and connecting recommendation to the specific part (e.g., by highlighting the part, overlaying the part etc.); (4) identifying an object and the objects approval for indoor use but not bathroom classification and figuring out from the context (other products in the scene from the scan) that it is in a bathroom environment and then recommending the user not to use the object in this environment (or recommending another product, approved for bathroom use), (5) identifying consumables and instructions for when/how to change, identifying a product which, for safety, requires it to be attached to the wall but recognizing that the object is not placed close enough to any wall and recommending the user to anchor the furniture to the wall; (6) identifying a product not approved for children in a context with other products which are approved children's products and notifying the customer that the product is not approved for children; (7) extracting contextual information including a room type being a kitchen with an identified object that is not approved for food and selecting a recommendation providing a warning to a user; (8) providing a recommendation to store food on a shelf in the fridge-e.g., on a shelf designed to store a specific type of food; (9) identifying loose cords close to children's bed or old type of blinds with cords and providing a warning; (10) identifying a mattresses directly on the floor and providing a warning that the arrangement does not give the right ventilation (e.g., that legs are needed); (11) presenting instructions for oils designed for the maintenance of the object or a suggestion on parts to replace; and/or (12) providing recommendation of products when shopping (e.g., identifying areas of wear etc.) including a condition of a second hand product.

Further alternative aspects of the present disclosure are described in the following numbered clauses.

Clause 1: A method for guiding a user interacting with an object, the method comprising: receiving, from a camera of an augmented reality (AR) device, a stream of images of a scene including the object; identifying the object in the stream of images; retrieving a set of recommendations for the object from an object recommendation data store; extracting contextual information from the stream of images; selecting a recommendation from the set of recommendations based at least in part on the contextual information; and sending to the AR device the recommendation for presenting in AR on a display of the AR device.

Clause 2: The method of clause 1, wherein the contextual information can include one or more of: (1) a setting; (2) a geographic location; (3) a lifecycle period of the object; (4) an environment type; (5) object defect (6) object use or misuse (7) object safety issue; or (8) any combination of (1), (2), (3), (4), (5), (6), and (7).

Clause 3: The method of clause 1, wherein the contextual information includes an object lifecycle period, the object lifecycle period including one of: (1) the object on display for sale; (2) the object during installation; (3) the object during use; and (4) the object at end of life.

Clause 4: The method of clause 1, wherein the AR device determines a surface of the object to present the recommendation in AR, and wherein the recommendation is presented attached to the determined surface.

Clause 5: The method of clause 4, wherein the surface is determined by: determining a pose of the object and non-occluded surfaces of the object based on the stream of images of the scene; and determining the surface based on the determined pose of the object and the determined non-occluded surfaces of the object.

Clause 6: The method of clause 5, wherein the surface is further determined by: determining a distance to the object and lighting conditions of the scene, wherein determining the surface is based further on the distance to the object and the lighting conditions of the scene.

Clause 7: The method of clause 1, wherein selecting the recommendation comprises: ranking the set of recommendations, wherein the ranking is based at least in part on the contextual information and the selected recommendation is the highest ranked recommendation.

Clause 8: The method of clause 7, wherein ranking the set of recommendations comprises: processing the set of recommendations with a machine learning model to score the set of recommendations based at least in part on the contextual information.

Clause 9: The method of clause 1, wherein the recommendation selected includes an object warning when the extracted contextual information includes an identified type of room in the scene that is not the type of room recommended for the object.

Clause 10: The method of clause 1, the method further comprising: identifying at least two surfaces of the object; selecting a surface recommendation for each of the at least two surfaces; and sending the surface recommendations to the AR device, wherein each of the surface recommendations is presented in AR attached to a corresponding surface of the at least two surfaces.

Clause 11: The method of clause 10, wherein each of the at least two surfaces are made of a different material and the recommendation selected for each of the at least two surfaces includes care information for each of the different materials.

Clause 12: The method of clause 1, further comprising: identifying an installation error based at least on the stream of images, the object, and the contextual information.

Clause 13: The method of clause 1, further comprising: identifying surfaces of the object; comparing the surfaces on the object to models stored in a database to identify a defect of a surface of the surfaces; and sending a message to the AR device to present a recommendation related to the defect in AR attached to the surface.

Clause 14: The method of clause 1, wherein the recommendation can include: (1) object materials; (2) object dimensions; (3) object care instructions; (4) disposal information; (5) sustainability information; (6) assembly information; (7) installation error information; (8) consumable/replacement information; (9) object intended use information; or any combination of (1), (2), (3), (4), (5), (6), (7), (8), and (9).

Clause 15: The method of clause 1, wherein the object is a product sold by a retailer.

Clause 16: The method of clause 1, wherein the recommendation is presented in AR with a 3D graphic.

Clause 17: The method of clause 1, wherein the recommendation is selected further based on at least one of customer reviews for the object and/or object return data.

Clause 18: An augmented reality (AR) device comprising: a camera; a display; at least one processor; and a memory device, the memory device storing instructions which when executed by the at least one processor cause the AR device to: capture with the camera a stream of images of a scene; provide the stream of images to a server operating a recommendation engine, wherein the recommendation engine processes the stream of images to identify an object and extract contextual information, retrieves a set of recommendations for the object, and selects a recommendation from the set of recommendations based at least in part on the contextual information; receive the recommendation from the server; and present the recommendation in AR on the display.

Clause 19: The AR device of clause 18, further comprising: a global positioning system (GPS) receiver configured to receive global position system data to determine a location of the AR device, wherein at the contextual information is further based on the location of the AR device.

Clause 20: The AR device of clause 18, wherein the AR device is one of smart glasses, a smart phone, or a computing tablet.

Clause 21: A virtual reality (VR) device comprising: a display; at least one processor; and a memory device, the memory device storing instructions which when executed by the at least one processor cause the VR device to: present a virtual scene with an object with an object ID; send the object ID to a server operating a recommendation engine, wherein the recommendation engine extracts contextual information, retrieves a set of recommendations for the object via the object ID, and selects a recommendation from the set of recommendations based at least in part on the contextual information; receive the recommendation; and present the recommendation in VR on the display.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A computer-implemented method for guiding a user interacting with an object, the method comprising:
receiving informational cues of a scene including the object, the informational cues pertaining to sensor-retrieved data;
identifying the object based on the informational cues;
extracting contextual information based on the informational cues;
determining at least one interaction indicator configured to indicate an interaction performable on the identified object, the at least one interaction indicator being based at least in part on the contextual information; and
guiding the user to perform the interaction on the object based on the at least one interaction indicator through control of a mixed reality MR device.

2. The computer-implemented method of claim 1, wherein the contextual information includes one or more of a setting; a geographic location; a lifecycle period of the object; an environment type; an object defect; an object use or misuse; an object safety issue; and/or any combination thereof.

3. The computer-implemented method of claim 1, wherein the contextual information includes an object lifecycle period, the object lifecycle period including one of the object on display for sale; the object during installation; the object during use; the object at end of life, and/or any combination thereof.

4. The computer-implemented method of claim 1, wherein guiding the user comprises determining a surface of the object, and wherein the at least one interaction indicator is provided attached to the determined surface.

5. The computer-implemented method of claim 4, wherein the surface is determined by:
determining a pose of the object and non-occluded surfaces of the object based on the informational cues being image and/or mesh data; and
determining the surface based on the determined pose of the object and the determined non-occluded surfaces of the object.

6. The computer-implemented method of claim 5, wherein the surface is further determined by:
determining a distance to the object and lighting conditions of the scene, wherein determining the surface is based further on the distance to the object and the lighting conditions of the scene.

7. The computer-implemented method of claim 1, wherein determining at least one interaction indicator comprises:
determining a plurality of interaction indicators of the identified object, and
ranking the plurality of interaction indicators, wherein the ranking is based at least in part on the contextual information and the determined at least one interaction indicator is the highest ranked interaction indicator among the plurality of interaction indicators.

8. The computer-implemented method of claim 7, wherein ranking the plurality of interaction indicators comprises processing the plurality of interaction indicators with a machine learning model to score the plurality of interaction indicators based at least in part on the contextual information.

9. The computer-implemented method of claim 1, wherein the at least one interaction indicator includes an object warning when the extracted contextual information includes an identified type of room in the scene that is not a type of room recommended for the object, wherein information pertaining to the type of room recommended for the object is obtained from a database.

10. The computer-implemented method of claim 1, the method further comprising:
identifying at least two surfaces of the object;
selecting a surface recommendation for each of the at least two surfaces; and
sending the surface recommendations to the MR device, wherein each of the surface recommendations is presented in MR attached to a corresponding surface of the at least two surfaces.

11. The computer-implemented method of claim 10, wherein each of the at least two surfaces are made of a different material and the recommendation selected for each of the at least two surfaces includes care information for each of the different materials.

12. The computer-implemented method of claim 1, further comprising:
identifying an installation error based at least on the informational cues, the object, and the contextual information.

13. The computer-implemented method of claim 1, further comprising:
identifying surfaces of the object;
comparing the surfaces of the object to surface models stored in a database to identify a defective surface; and
sending a message to the MR device to provide a recommendation related to the defective surface.

14. The computer-implemented method of claim 1, wherein the at least one interaction indicator includes one or more of object materials; object dimensions; object care instructions; disposal information; sustainability information; assembly information; installation error information; consumable/replacement information; object intended use information; and/or any combination thereof.

15. The computer-implemented method of claim 1, wherein the object is a product sold by a retailer.

16. The computer-implemented method of claim 1, wherein the at least one interaction indicator is presented as 3D graphic on the MR device.

17. The computer-implemented method of claim 16, wherein the 3D graphic presented on the MR device is an instructional avatar user virtually carrying out said interaction.

18. The computer-implemented method of claim 1 any preceding claim, wherein the at least one interaction indicator is selected based on at least one of customer reviews for the object and/or object return data.

19. The computer-implemented method of claim 1, wherein the informational cues include one of image data, mesh data, auditory data, tactile data, ambient data, motion data, olfactory data, or any combination thereof.

20. The computer-implemented method of claim 1, wherein the at least one interaction indicator is a visual, auditory or haptic signal.

21. A mixed reality MR device comprising:
a camera;
a display;
at least one processor; and
a memory device, the memory device storing instructions which when executed by the at least one processor cause the MR device to:
obtain informational cues of a scene;
process the informational cues to identify an object and extract contextual information;
determine at least one interaction indicator configured to indicate an interaction performable on the identified object, the interaction indicator being based at least in part on the contextual information; and
guide a user to perform the interaction on the object based on the at least one interaction indicator through control of the MR device.

22. (canceled).

23. (canceled).

24. (canceled).

25. The MR device of claim 21, wherein the MR device is one of smart glasses, a smart phone, or a computing tablet.

26. A server comprising a processing unit, wherein the processing unit is configured to:
process informational cues received from mixed reality, MR, device to identify an object and extract contextual information;
determine at least one interaction indicator configured to indicate an interaction performable on the identified object, the interaction indicator being based at least in part on the contextual information; and
communicate the at least one interaction indicator to the MR device for providing guidance to a user to perform the interaction on the object based on the at least one interaction indicator through control of the MR device.
